(19) United States
(12) Patent Application Publication
(10) Pub. No.: US 2026/0285654 A1
(43) Pub. Date: Sep. 24, 2026

(54) SCREW JACK FOR VEHICLES AND ASSEMBLY THEREOF

(71) Applicant: HCL Technologies Limited, New Delhi (IN)

(72) Inventor: Sridhar Sukumar, Chennai (IN)

(21) Appl. No.: 19/342,727

(22) Filed: Sep. 29, 2025

(30) Foreign Application Priority Data
Mar. 20, 2025 (IN) 202511025105

(51) Int. Cl. B66F 5/02

(52) U.S. Cl. CPC B66F 5/025

(57) ABSTRACT

A screw jack is disclosed. The screw jack may include a frame. The frame may include a first plate and a second plate. Further, the screw jack may include a roller coupled to the first plate. Further, the screw jack may include a c-channel coupled to the second plate. The c-channel may include a fastening mechanism configured to be detachably coupled to a first rail of a vehicle. Once the fastening mechanism is coupled, the c-channel establishes a secure connection with the first rail.

### DESCRIPTION

### Technical Field

This disclosure relates generally to screw jacks, and more particularly to a screw jack for vehicles and assembly thereof.

### Background

Generally, a conventional screw jack may be designed with a stationary flat base and an upper plate. The stationary flat base may rest on the ground, while the upper plate may contact the vehicle by turning the screw lever. The conventional screw jack may be typically used to lift a vehicle for tasks such as changing a flat tire. However, elderly or less physically able passengers may often struggle with lifting the spare wheel out of the storage compartment and loosening the wheel nuts to replace the flat tire and may also find it difficult to change the spare wheel. The spare wheel is often stored in the trunk or under the vehicle and is heavy to lift. Lifting the spare wheel may require significant physical strength and may be particularly challenging for individuals with limited mobility or strength. The nuts in the wheel are typically tightened such that it becomes difficult to loosen them, without the proper tools and physical efforts. Moreover, lifting the wheels is a strenuous task especially for individuals who do not have necessary strength or tools.

Additionally, conventional screw jacks also require manual operation to lift the vehicle. Once the screw jack is in place, lifting the vehicle may require turning a screw lever of the screw jack. Turning the screw lever may be physically demanding and time consuming. Moreover, positioning the screw jack correctly under the vehicle may be tricky and may require prior knowledge and precision. Even after the screw jack is correctly positioned, ensuring that the vehicle is stable and secure may be crucial to prevent any accidents. To add to the above challenges, changing the tire on the roadside may be dangerous, especially in poor weather conditions and on busy roads. The aforementioned challenges can be avoided by either driving the vehicle to a nearby garage in spite of a puncture or calling for roadside assistance or a tow truck. However, these solutions are either time-consuming or costly, or both.

Therefore, there is a need for a screw jack that may help solve these challenges.

### SUMMARY

In one embodiment, a screw jack is disclosed. In one example, the screw jack may include a frame. The frame may include a first plate and a second plate. The screw jack may further include a roller coupled to the first plate. The screw jack may further include a c-channel coupled to the second plate. The c-channel may include a fastening mechanism. The fastening mechanism may be configured to be detachably coupled to a first rail of a vehicle. Once the fastening mechanism is coupled, the c-channel establishes a secure connection with the first rail.

In another embodiment, a screw jack assembly is disclosed. In one example, the screw jack assembly may include a frame. The frame may include a first end of the frame. The screw jack assembly may further include a first plate. The first plate may be configured to be coupled to the first end of the frame. The screw jack assembly may further include a roller. The roller may be configured to be detachably coupled to the first plate. The screw jack may further include a second plate. The second plate may be configured to be coupled to the second end of the frame. The screw jack assembly may further include a c-channel. The c-channel may be configured to be coupled to the second plate. The c-channel may include a first slot configured to be aligned with a second slot formed within a first rail of a vehicle. The screw jack may further include a fastening mechanism. The fastening mechanism may be configured to couple the c-channel to the first rail using the first slot aligned with the second slot. Once the fastening mechanism is coupled, the c-channel establishes a secure connection with the first rail.

In yet another embodiment, a vehicle is disclosed. In one example, the vehicle may include a chassis. The chassis may include a first rail. The first rail may include a second slot, and a nut welded to the second slot. The chassis may further include a second rail. The second rail may be coupled to the chassis and the first rail. The vehicle may further include a screw jack detachably coupled to the first rail. The screw jack may include a frame. The frame may include a first plate and a second plate. The frame may further include a roller coupled to the first plate. The frame may further include a c-channel coupled to the second plate. The c-channel may include a first slot, and a bolt configured to be screwed into the first slot to establish a secure connection with the second slot of the first rail. Once the c-channel establishes a secure connection with the first rail, the roller is configured to enable movement of the vehicle in absence of an associated wheel of the vehicle.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exploded view of a screw jack assembly, in accordance with an embodiment of the present disclosure.

FIG. 2A illustrates a front view of a screw jack coupled to a first rail of a vehicle, in accordance with an embodiment of the present disclosure.

FIG. 2B illustrates a perspective view of a screw jack coupled to a first rail of the vehicle, in accordance with an embodiment of the present disclosure.

FIG. 3 illustrates a perspective view of a screw jack attached to a vehicle, in accordance with an embodiment of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

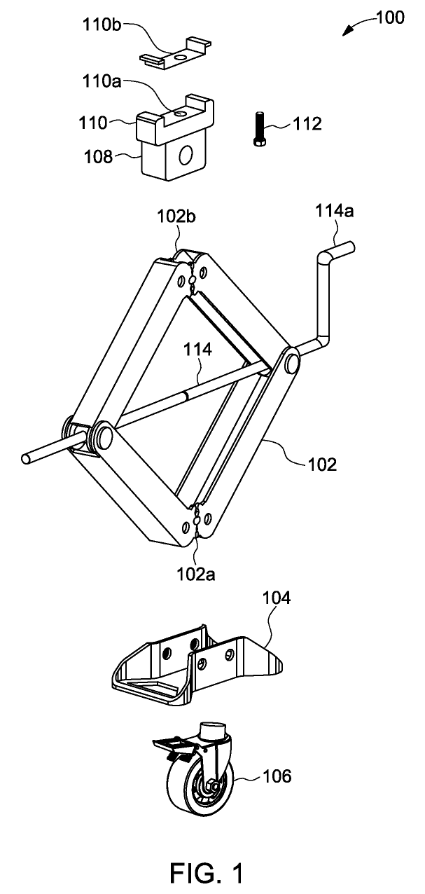

Referring now to FIG. 1, an exploded view 100 of a screw jack assembly, in accordance with an embodiment of the present disclosure is disclosed. The screw jack assembly may include a frame 102, a first plate 104, a roller 106, a second plate 108, a c-channel 110, a bolt 112, and a lead screw 114. The frame 102 may include a first end 102a and a second end 102b. The first plate 104 is configured to be coupled to the first end 102a of the frame 102 and the roller 106 is configured to be detachably coupled to the first plate 104. By way of an example, the roller 106 may include, but is not limited to a medium-duty castor wheel or a heavy-duty castor wheel. The size of the medium-duty castor wheel may be 4 to 8 inches and may endure a load of 150 kgs to 500 kgs per wheel. The size of the heavy-duty castor wheels may be 4 to 10 inches and may endure a load of 500 kgs to 2000 kgs per wheel. A type associated with the roller 106 detachably coupled to the first plate 104, may vary depending on the size of a vehicle.

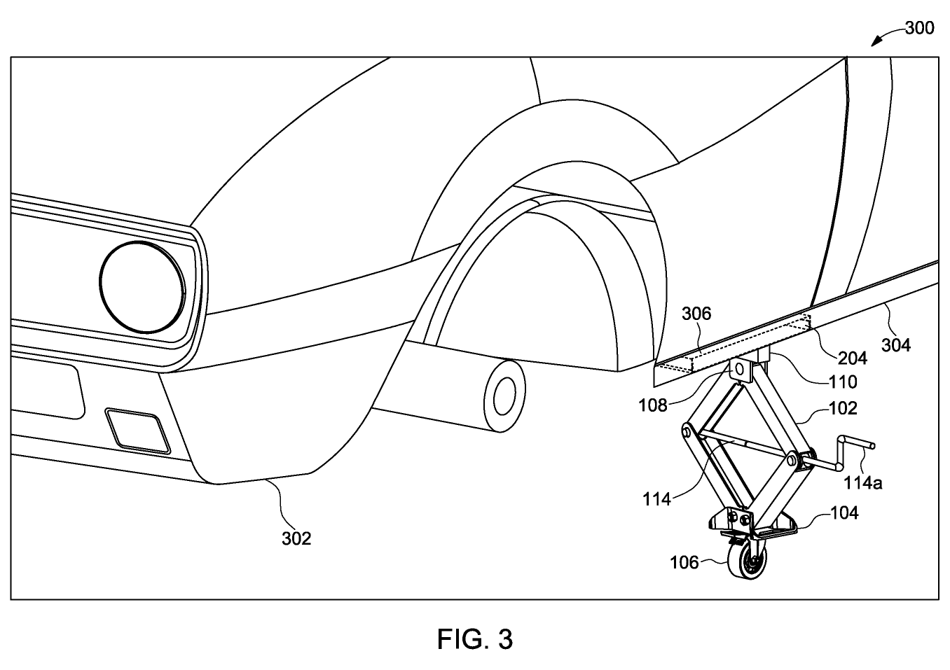

Further, the second plate 108 is configured to be coupled to the second end 102b of the frame 102 and the c-channel 110 is configured to be coupled to the second plate 108. The c-channel 110 may include a first slot 110a. In an embodiment, the first slot 110a is configured to be aligned with a second slot formed within a first rail of the vehicle (as explained in greater detail in conjunction with FIG. 3). The c-channel 110 may also include a fastening mechanism configured to be detachably coupled to a first rail of the vehicle. In some embodiments, the c-channel 110 may include a padding 110b (for example, a rubber padding, a silicon padding, nitrile padding, etc.) configured to be sandwiched between the c-channel 110 and the first rail. The fastening mechanism may include the bolt 112 (for example, shoulder bolt, square bolt, plow bolt, flange bolt, hex bolt, etc.) configured to be screwed into the first slot 110a formed within the c-channel 110 and a second slot formed within the first rail of the vehicle. The first rail may include a nut welded onto the second slot and configured to receive the bolt 112 being screwed into the first slot 110a and the second slot.

The frame 102 may include a lead screw 114. The lead screw 114 may include a lever 114a that is configured to move the second plate 108 relative to the first plate 104 in direction perpendicular to the axis of rotation of the lead screw 114. As the lead screw 114 is operated and the second plate 108 moves relative to the first plate 104 in an upward direction, the c-channel 110 establishes a connection with the first rail of the vehicle. In order to secure the connection thus established, the bolt 112 in the c-channel 110 is configured to be screwed into the first slot 110a and the padding 110b (the padding 110b may also include a slot) formed within the c-channel 110 and a second slot formed within the first rail of the vehicle. Once the c-channel 110 establishes a secure connection with the first rail, the roller 106 is configured to enable movement of the vehicle in absence of an associated wheel. As the vehicle moves, the padding 110b may absorb the vibrations caused by the movement of the vehicle.

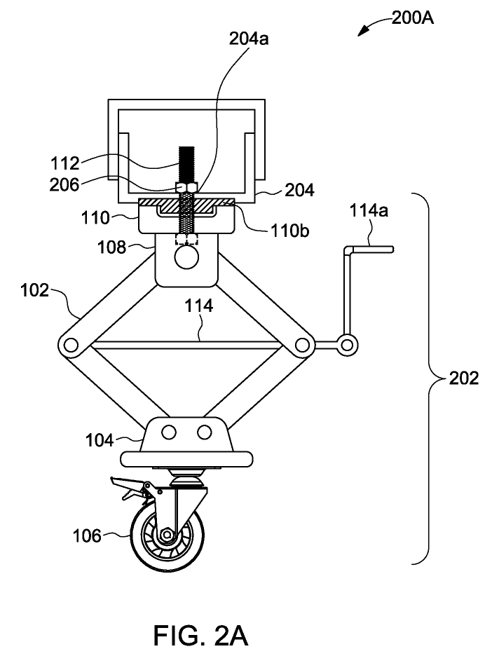

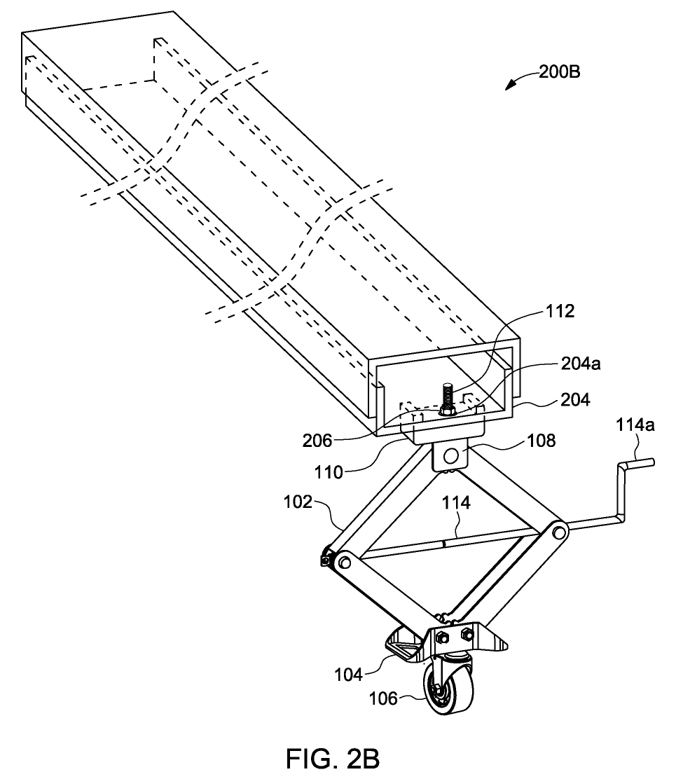

Referring now to FIG. 2A, a front view 200A of a screw jack 202 coupled to a first rail 204 of a vehicle is illustrated, in accordance with an embodiment of the present disclosure. FIG. 2A is explained in conjunction with FIG. 1. In an embodiment, the screw jack 202 may include the frame 102. The frame 102 may include the first plate 104 and the second plate 108. The screw jack 202 may further include the roller 106 coupled to the first plate 104. The roller 106 may make it easy to position the screw jack 202 accurately without requiring much physical effort. The screw jack 202 may further include the c-channel 110 coupled to the second plate 108. The c-channel 110 may include a fastening mechanism configured to be detachably coupled to the first rail 204 of the vehicle. The first rail 204 may be coupled to a second rail (for example, a second rail 306). The first rail 204 and the second rail are a part of a chassis of a vehicle (as explained in greater detail in conjunction with FIG. 3). The fastening mechanism may include the bolt 112 configured to be screwed into the first slot 110a formed within the c-channel 110 and a second slot 204a formed within the first rail 204 of the vehicle. The first rail 204 may include a nut 206 welded onto the second slot 204a. The second slot 204a is configured to receive the bolt 112 being screwed into the first slot 110a and the second slot 204a. The c-channel 110 may further include the padding 110b coupled to the c-channel 110 and the first rail 204. The padding 110b is configured to be sandwiched between the c-channel 110 and the first rail 204.

The screw jack 202 may further include the lead screw 114. The lead screw 114 may include the lever 114a. The lever 114a is configured to move the second plate 108 relative to the first plate 104 in direction perpendicular to the axis of rotation of the lead screw 114. The rotation of the lever 114a may initiate the conversion of rotary motion into vertical linear motion. As the lever 114a rotates, the second plate 108 moves in an upward direction. Further, a connection is established between the c-channel 110 and the first rail 204. The bolt 112 is then screwed into the nut 206 welded onto the second slot 204a of the first rail 204. As the bolt 112 is locked into the nut 206, the c-channel 110 establishes a secure connection with the first rail 204 of the vehicle. Continued rotation of the lever 114a may lift the vehicle to a certain height. Further, the roller 106 is configured to enable movement of the vehicle in absence of an associated wheel of the vehicle. Alternatively, or additionally, the roller 106 may also provide an additional stability to the vehicle while changing the wheel of the vehicle.

Referring now to FIG. 2B, a perspective view 200B of the screw jack 202 coupled to the first rail 204 of the vehicle is illustrated, in accordance with an embodiment of the present disclosure. FIG. 2B is explained in conjunction with FIG. 1 and FIG. 2A. The screw jack 202 may include the roller 106 coupled to the first plate 104 and a c-channel 110 coupled to the second plate 108. The c-channel 110 may include a bolt 112 configured to be screwed into the first slot 110a formed within the c-channel 110 and the second slot 204a formed within the first rail 204 of the vehicle. The first rail 204 may include a nut 206 welded onto the second slot 204a. The second slot 204a is configured to receive the bolt 112 being screwed into the first slot 110a and the second slot 204a. The c-channel 110 may further include the padding 110b configured to be sandwiched between the c-channel 110 and the first rail 204 upon coupling of the bolt 112 with the nut 206.

Referring now to FIG. 3, a perspective view 300 of the screw jack 202 coupled to a vehicle 302 is illustrated, in accordance with an embodiment of the present disclosure. FIG. 3 is explained in conjunction with FIG. 1, FIG. 2A, and FIG. 2B. The vehicle 302 may include a chassis 304. The chassis 304 may include the first rail 204 and the second rail 306. The first rail 204 may include the second slot 204a. The first rail 204 may further include the nut 206 welded to the second slot 204a. The vehicle 302 may further include the second rail 306 coupled to the chassis 304 and the first rail 204. The vehicle 302 may include the screw jack 202 detachably coupled to the first rail 204. As explained in the above figures, the screw-jack 202 establishes a secure connection with the first rail 204 of the chassis 304. Continued rotation of the lever 114a may then lift the vehicle to a certain height. Once the secure connection is established, the roller 106 is configured to enable movement of the vehicle in absence of an associated wheel of the vehicle 302. Additionally, or alternatively, the roller 106 provides stability to the vehicle 302 while changing the associated wheel of the vehicle 302.

A representative example of the vehicle 302 may be a car. However, it should be noted that the embodiments of the present disclosure may be employed in any vehicle where the screw jack assembly is similarly arranged. In an exemplary scenario, the vehicle 302 gets a flat tire on a busy road. Due to the busy road, it may be dangerous and difficult for a user (e.g., a driver, a passenger, etc.) to change the tire of the car. To be safe, the vehicle 302 is to be rolled to a nearby service center or a safe place to change the tire. Therefore, the user may retrieve the screw jack 202 with help of the roller 106 and may place the screw jack 202 beneath the chassis 304 at a predefined jacking position of the vehicle 302. It should be noted that the predefined jacking position may be dependent on the type of vehicle. The roller 106 may make it easy for the user to position the screw jack 202 accurately without requiring much physical effort.

Once the screw jack 202 is placed beneath the chassis 304, the user may begin to rotate the lever 114a of the lead screw 114. The rotation of the lever 114a may initiate a conversion of rotary motion into vertical linear motion. As the lever 114a rotates, the second plate 108 may move in an upward direction. Continued rotation of the lever 114a may lift the tire off the ground. The vertical linear motion may raise the vehicle 302. The roller 106 may provide additional stability and ease of movement. The roller 106 may make it possible to drive the vehicle 302 over a short distance to the nearby service center or to a safe location. The padding 110b in the c-channel 110 may absorb the vibrations caused by the movement of the vehicle 302. The padding 110b may prevent any discomfort caused to the passenger by the movement of the vehicle.

The techniques described above relate to a screw jack for vehicles and assembly thereof. The above techniques reduce the physical effort required to position and operate the screw jack, making it accessible for elderly or less physically able individuals. The above techniques may provide stability for the vehicle during the lifting process. The above techniques may also allow the vehicle to be moved to a short distance to a safer or more convenient location for tire repair.

In light of the above-mentioned advantages and the technical advancements provided by the disclosed device and mechanism, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It is intended that the disclosure and examples be considered as exemplary only, with a true scope and spirit of disclosed embodiments being indicated by the following claims.

What is claimed is:

1. A screw jack comprising:
a frame comprising a first plate and a second plate;
a roller coupled to the first plate; and
a c-channel coupled to the second plate, wherein the c-channel comprises:
a fastening mechanism configured to be detachably coupled to a first rail of a vehicle, wherein once the fastening mechanism is coupled, the c-channel establishes a secure connection with the first rail.

2. The screw jack of claim 1, wherein once the c-channel establishes a secure connection with the first rail, the roller is configured to enable movement of the vehicle in absence of an associated wheel of the vehicle.

3. The screw jack of claim 1, further comprises a padding coupled to the c-channel, wherein the padding is configured to be sandwiched between the c-channel and the first rail upon coupling of the fastening mechanism.

4. The screw jack of claim 1, wherein the fastening mechanism comprises a bolt configured to be screwed into a first slot formed within the c-channel and a second slot formed within the first rail of the vehicle, and wherein the first rail comprises a nut welded onto the second slot and configured to receive the bolt being screwed into the first slot and the second slot.

5. The screw jack of claim 1, further comprising a lead screw, wherein the lead screw comprises a lever configured to move the second plate relative to the first plate in direction perpendicular to the axis of rotation of the lead screw.

6. A screw jack assembly comprising:
a frame comprising a first end and a second end;
a first plate configured to be coupled to the first end of the frame;
a roller configured to be detachably coupled to the first plate;
a second plate configured to be coupled to the second end of the frame;
a c-channel configured to be coupled to the second plate, wherein the c-channel comprises a first slot configured to be aligned with a second slot formed within a first rail of a vehicle; and
a fastening mechanism configured to couple the c-channel to the first rail using the first slot aligned with the second slot, wherein once the fastening mechanism is coupled, the c-channel establishes a secure connection with the first rail.

7. The screw jack assembly of claim 6, wherein once the c-channel establishes a secure connection with the first rail, the roller is configured to enable movement of the vehicle in absence of an associated wheel of the vehicle.

8. The screw jack assembly of claim 6, further comprises a padding coupled to the c-channel, wherein the padding is configured to be sandwiched between the c-channel and the first rail upon coupling of the fastening mechanism.

9. The screw jack assembly of claim 6, wherein the fastening mechanism comprises a bolt configured to be screwed into the first slot formed within the c-channel and a second slot formed within the first rail of the vehicle, and wherein the first rail comprises a nut welded onto the second slot and configured to receive the bolt being screwed into the first slot and the second slot.

10. The screw jack assembly of claim 6, further comprising a lead screw, wherein the lead screw comprises a lever configured to move the second plate relative to the first plate in direction perpendicular to the axis of rotation of the lead screw.

11. A vehicle comprising:
a chassis, wherein the chassis comprising:
a first rail comprising:
a second slot; and
a nut welded to the second slot;
a second rail coupled to the chassis and the first rail;
a screw jack detachably coupled to the first rail, wherein the screw jack comprises:
a frame comprising a first plate and a second plate;
a roller coupled to the first plate; and
a c-channel coupled to the second plate, wherein the c-channel comprises:
a first slot; and
a bolt configured to be screwed into the first slot to establish a secure connection with the second slot of the first rail, wherein once the c-channel establishes a secure connection with the first rail, the roller is configured to enable movement of the vehicle in absence of an associated wheel of the vehicle.

13. The vehicle of claim 11, wherein the screw jack comprises a padding coupled to the c-channel, wherein upon coupling, the padding is configured to be sandwiched between the c-channel and the first rail.

14. The vehicle of claim 11, wherein the nut welded onto the second slot is configured to receive the bolt being screwed into the first slot and the second slot.

15. The vehicle of claim 11, wherein the screw jack comprises a lead screw, wherein the lead screw comprises a lever configured to move the second plate relative to the first plate in direction perpendicular to the axis of rotation of the lead screw.
